(19) United States
(12) Patent Application Publication
(10) Pub. No.: US 2005/0200799 A1
(43) Pub. Date: Sep. 15, 2005

(54) Electro-optical device, method of manufacturing the same, and electronic apparatus

(75) Inventor: Ichiro Murai, Koufu-si (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/037,156

(22) Filed: Jan. 19, 2005

(30) Foreign Application Priority Data
Mar. 15, 2004 (JP) 2004-072685

(51) Int. Cl. G02F 1/1339

(52) U.S. Cl. 349/156

(57) ABSTRACT

To prevent the unevenness of color caused by nonuniformity in the gap between a pair of substrates and to realize a high quality image display in an electro-optical device. An electro-optical device of the present invention comprises a pair of substrates with an electro-optical material interposed therebetween, a sealing material, formed between the pair of substrates and in a sealing region which is disposed around an image display region on one substrate, for bonding the pair of substrates to each other, and first columnar spacers and second columnar spacers which are respectively provided to keep a gap between the pair of substrates in the image display region at a predetermined value. Further, between the pair of substrates, the first columnar spacers are arranged in the image display region and the second columnar spacers are arranged outside the sealing region in a peripheral region which is disposed around the image display region.

### BACKGROUND

The present invention relates to an electro-optical device and an electronic apparatus. More specifically, the present invention relates to an electro-optical device in which a columnar spacer is used to maintain an interval (gap) between a pair of substrates at a predetermined value, a method of manufacturing the same, and an electronic apparatus having the electro-optical device.

As such an electro-optical device, for example, a liquid crystal device in which a pair of substrates are bonded by means of a sealing material with liquid crystal serving as an electro-optical material interposed therebetween is known. In such a liquid crystal device, in order to maintain the clearance interval between the pair of substrates, that is, a gap, columnar spacers may be provided between the pair of substrates (see Patent Documents 1 to 3).

According to Patent Document 1 or 3, a technique in which a gap between a pair of substrates is adjusted in an image display region disposed inside a sealing region on which a sealing material is formed, and also in a peripheral region around the image display region inside the sealing region is disclosed. According to this technique, by arranging columnar spacers having the same height in the image display region and the peripheral region inside the sealing region between the pair of substrates, the gap between the pair of substrates is adjusted.

Further, according to Patent Document 2, between a pair of substrates, by changing the configuration of a laminated structure formed on a side which faces an electro-optical material on at least one of the pair of substrates and by arranging columnar spacers on the laminated structure, a gap between the pair of substrates is adjusted.

[Patent Document 1] Japanese Patent No. 3388463.

[Patent Document 2] Japanese Unexamined Patent Application Publication No. 11-119252.

[Patent Document 3] Japanese Unexamined Patent Application Publication No. 2000-338504.

Here, as disclosed in Patent Document 1, the gap between the pair of substrates may have different values in the image display region and in the peripheral region between the pair of substrates. This is because, on at least one of the pair of substrates, the configuration of the laminated structure formed on a side facing the other substrate is different in the image display region and in the peripheral region (see FIG. 7 in Patent Document 1). As a result, in this case, the columnar spacers arranged in the peripheral region float and then cannot perform their normal functions. In subsequent steps such as a step of bonding the pair of substrates or a liquid crystal injection step to be performed after the step of bonding the pair of substrates, if the compression stress acts on the pair of substrates, the peripheral region is drastically pressed as compared to the central portion of the image display region. And then, between the pair of substrates bonded to each other, the gap becomes large in the central portion of the image display region and becomes small toward the sealing region. The gap between the pair of substrates has a different value in the image display region and in the peripheral region. Further, if the compression stress acts on the pair of substrates, the peripheral region is drastically pressed as compared to the central portion of the image display region, which may then crush the columnar spacers arranged in the peripheral region. Thus, in any cases, the pair of substrates are bonded in a convex shape warp.

Therefore, if an image display is performed on an electro-optical device which is manufactured with a pair of warped substrates, there is a problem in that a severe unevenness in color is generated in the periphery of the image display region.

The present invention is made in consideration of the problems described above, and it is an object of the present invention to provide an electro-optical device which can prevent the unevenness of color from being caused by the nonuniformity in the gap between a pair of substrates and which can perform a high quality image display, a method of manufacturing the same, and an electronic apparatus, such as a liquid crystal projector, comprising the electro-optical device.

### SUMMARY

In order to solve the problems described above, there is provided an electro-optical device of the present invention comprising a pair of substrates with an electro-optical material interposed therebetween, a sealing material, formed between the pair of substrates and in a sealing region which is disposed around an image display region on one substrate, for bonding the pair of substrates to each other, and first columnar spacers and second columnar spacers which are respectively provided to keep a gap between the pair of substrates in the image display region at a predetermined value. Further, between the pair of substrates, the first columnar spacers are arranged in the image display region and the second columnar spacers are arranged outside the sealing region in a peripheral region which is disposed around the image display region.

According to the electro-optical device of the present invention, in a manufacturing process thereof, the sealing material made of, for example, an ultraviolet curing resin or a thermosetting resin is formed in the sealing region which is disposed around the image display region between the pair of substrates. And then, between the pair of substrates which are bonded by means of the sealing material, for example, an electro-optical material such as liquid crystal is injected from an injection port which is partially formed in the sealing region. In an electro-optical device manufactured in such a manner, at the time of the operation, the incident light from a light source passes through the electro-optical material in each pixel and is emitted as display light, such that an image display is performed.

In the electro-optical device of the present invention, on at least one of the pair of substrates, the first and second columnar spacers are provided. The first and second columnar spacers are made of a transparent film such as a polyimide film or an acryl film. And then, the first columnar spacers are provided in the image display region, and the second columnar spacers are provided outside the sealing region.

The first and second columnar spacers have different heights from each other or have different sectional areas from each other when being cut in a direction orthogonal to a height direction thereof. In addition, the first and second columnar spacers are formed at different formation densities from each other.

Here, a step in the image display region and the peripheral region is generated in a substrate surface between the pair of the substrates, and thus the gap between the pair of substrates has a different value in the image display region and in the peripheral region. This is because, on at least one of the pair of substrates, a configuration of a laminated structure which is formed on a side facing the other substrate is different in the image display region and in the peripheral region.

In this case, by means of the first and second columnar spacers having the different heights from each other, the clearance interval between the pair of substrates, that is, the gap is controlled. For example, when the gap between the pair of substrates is relatively larger in the peripheral region than in the image display region, the steps generated in the substrate surface are compensated by means of the second columnar spacers higher than the first columnar spacers, such that the second columnar spacers do not float between the pair of substrates. Here, the heights of the first columnar spacers and the second columnar spacers themselves may be adjusted. Alternatively, on the substrate on which the columnar spacers are to be formed, a dummy layer may be previously formed at the forming positions, and then the columnar spacers may be formed on the dummy layer such that the heights of the columnar spacers are adjusted. In the case in which the second columnar spacers are also arranged in the sealing region, the heights of the second columnar spacers themselves are preferably adjusted.

Accordingly, between the pair of substrates, the gap in the image display region is kept at a predetermined value by means in the first columnar spacers, and simultaneously the gap in the peripheral region is kept at a value different from the gap of the image display region, that is, at a value larger than the predetermined value by means of the second columnar spacers. At this time, even when the stress that causes the gap in the peripheral region to be small, as compared to the image display region, is caused by the warpage of the substrates, the second columnar spacers are provided in a region near to an edge of the substrate outside the sealing region, such that the gap in the peripheral region is effectively prevented from being narrowed. Further, the columnar spacers have an advantage in that the gap is stably kept in a surface direction between the pair of substrates bonded to each other, as compared to the case in which beadlike spacers are used.

Thus, in subsequent steps such as a step of bonding the pair of substrates or a liquid crystal injection step that follows the step of bonding the pair of substrates, even when the compression stress acts on the pair of substrates, the gap between the pair of substrates is kept by means of the first and second columnar spacers as described above. Thus, the pair of substrates can be prevented from being warped in a convex shape.

Alternatively, as described above, the first and second columnar spacers have different sectional areas from each other or are formed with a different formation density from each other. In this case, between the pair of substrates, the degree of strength of the first columnar spacers in the image display region and the degree of strength of the second columnar spacers in the peripheral region have different values from each other. Specifically, the degree of strength of the second columnar spacers in the peripheral region may be sufficiently larger than that of the first columnar spacers in the image display region between the pair of substrates. Thus, even when the compression stress acts on the pair of substrates in the subsequent steps and then the peripheral region is drastically pressed as compared to the central portion of the image display region, it is difficult to crush the second columnar spacers. Therefore, if the second columnar spacers are provided with a degree of strength higher than that of the first columnar spacers, the second columnar spacers are not crushed in the subsequent steps, and thus the pair of substrates can be prevented from being warped in the convex shape.

Thus, according to the electro-optical device of the present invention, gap spots in the image display region are reduced. Therefore, at the time of the image display, the unevenness in color can be prevented. As a result, a high quality image display can be performed.

Moreover, in the electro-optical device, if the size of the image display region becomes large, a problem that the pair of substrates warps more drastically in a convex shape due to the presence of compression stress as described above in the subsequent steps is likely to be caused. According to the electro-optical device of the present invention, the size of the image display region is preferably in a range of from 3 to 15 inches. Thus, the advantages as described above can be obtained in the most effective manner.

In an aspect of the electro-optical device of the present invention, in the peripheral region, the second columnar spacers are provided with the sealing material in the sealing region, or, in addition to or instead of the sealing material, the second columnar spacers are arranged within the sealing region.

According to this aspect, on at least one of the pair of substrates, among the first and second columnar spacers having the different heights from each other, the ones having adjusted with the height are arranged in the sealing region. In this case, the first and second columnar spacers are provided in the form with the sealing material. Thus, by means of the first and second columnar spacers provided in such a manner, the gap between the pair of substrates can be controlled.

In another aspect of the electro-optical device of the present invention, the first columnar spacers have different heights from the second columnar spacers.

In this aspect, the warpage in each of the pair of substrates bonded by means of the sealing material in the electro-optical device is reduced. Further, an advantage that the gap spots in the image display region are reduced can be obtained.

In another aspect of the electro-optical device of the present invention, the first columnar spacers have different sectional areas from the second columnar spacers when being cut in a direction orthogonal to a height direction thereof.

In this aspect, the warpage in each of the pair of substrates bonded by means of the sealing material in the electro-optical device is reduced. Further, an advantage that the gap spots in the image display region are reduced can be obtained.

In another aspect of the electro-optical device of the present invention, between the pair of substrates, the first columnar spacers are formed with a different formation density from the second columnar spacers.

In this aspect, the warpage in each of the pair of substrates bonded by means of the sealing material in the electro-optical device is reduced. Further, an advantage that the gap spots in the image display region are reduced can be obtained.

In another aspect of the electro-optical device of the present invention, the first and second columnar spacers are provided on one of the pair of substrates.

According to this aspect, by means of the first and second columnar spacers having the different heights from each other, the gap between the pair of substrates is controlled.

Further, the first and second columnar spacers having the different sectional areas or formation densities from each other are provided on one of the pair of substrates. In this case, the degree of strength of the first columnar spacers and the degree of strength of the second columnar spacers have different values from each other. Specifically, the degree of strength of the second columnar spacers is sufficiently larger than that of the first columnar spacers. Thus, even when the compression stress acts on the pair of substrates in the subsequent steps and then the peripheral region is drastically pressed as compared to the central portion of the image display region, it is difficult to crush the second columnar spacers. Therefore, the warpage in each of the pair of substrates bonded by means of the sealing material is reduced. Further, the gap spots in the image display region are reduced.

In another aspect of the electro-optical device of the present invention, the first columnar spacers are provided on one of the pair of substrates, and the second columnar spacers are provided on the other substrate.

According to this aspect, by means of the first and second columnar spacers having different heights from each other, the gap between the pair of substrates is controlled. Further, the degree of strength of the second columnar spacers may be sufficiently larger than that of the first columnar spacers. Thus, even when the compression stress acts on the pair of substrates in the subsequent steps and then the peripheral region is drastically pressed as compared to the central portion of the image display region, it is difficult to crush the second columnar spacers. Therefore, the warpage in each of the pair of substrates bonded by means of the sealing material is reduced. Further, the gap spots in the image display region are reduced.

In another aspect of the electro-optical device of the present invention, on at least one of the pair of substrates on which the first or second columnar spacers are provided, a dummy layer is provided outside the sealing region and the second columnar spacers are provided below or above the dummy layer.

According to this aspect, the heights of the second columnar spacers can be made to be larger than the heights of the first columnar spacers. Thus, in the case in which the gap between the pair of substrates is relatively larger in the peripheral region than in the image display region, the steps generated in the substrate surface are compensated by means of the second columnar spacers relatively higher than the first columnar spacers, such that the second columnar spacers do not float between the pair of substrates. Moreover, the dummy layer may be made of a single layer or multiplayer. Further, the dummy layer is preferably made of the same film as that to be included in the laminated structure which is formed on at least one substrate of the pair of substrates. Thus, the dummy layer can be formed rather easily.

In another aspect of the electro-optical device of the present invention, on at least one of the pair of substrates on which the first or second columnar spacers are provided, a laminated structure which extends from the image display region to the peripheral region is formed.

According to this aspect, on at least one of the pair of substrates, the laminated structure in which various films such as conductive films or interlayer insulating films are laminated is formed extending from the image display region to the peripheral region. According to this aspect, by the means of various films included in the laminated structure, a pixel electrode is formed for every pixel in the image display region and various electronic elements such as various wiring lines, capacitances or electrodes for driving the pixel electrode are formed.

Here, if the configuration of such a laminate structure is different in the image display region and in the peripheral region, the gap between the pair of substrates has a different value in the image display region and in the peripheral region. In this case, by the means of the first and second columnar spacers, the warpage in each of the pair of substrates bonded by means of the sealing material can be reduced.

Moreover, in the pair of substrates, the sealing material is preferably adhered directly to the pair of the substrates, without forming the laminated structure in the sealing region. Thus, the pair of substrates can be bonded more stably via the sealing material.

In this aspect in which the laminated structure is formed on at least one of the pair of substrates, the laminated structure may include a light-shielding film which defines a non-opened region for every pixel in the image display region, and the first columnar spacers may be provided below the light-shielding film.

Accordingly, the first columnar spacers are arranged in the non-opened regions which do not contribute to the image display. Thus, the display light is not scatter by the first columnar spacers, which prevents the display quality in each pixel from being deteriorated.

Further, in this aspect in which the laminated structure is formed on at least one of the pair of substrates, the laminated structure may include a colored layer which is formed for every pixel in the image display region.

Accordingly, a color display in the image display region can be performed. More specifically, by providing three colored layers of a red colored layer, a green colored layer and a blue colored layer corresponding to three pixels of a red pixel, a green pixel and a blue pixel in the image display region, a color display can be performed.

Here, since the colored layer is formed with a relatively thick film, it is understood that, between the pair of substrates, the gap is relatively larger in the peripheral region in which the colored layer is not formed than in the image display region. However, in the present invention, even when the gap between the pair of substrates is different in the image display region and in the peripheral region in the electro-optical device, the warpage in each of the pair of substrates bonded by the sealing material can be reduced by the means of the first and second columnar spacers.

Further, in this aspect in which the laminated structure is formed on at least one of the pair of substrates, the laminated structure may include a reflecting film which is formed for every pixel in the image display region and defines a transmission display region and a reflection display region in each pixel.

Accordingly, the electro-optical device can be configured as a transflective electro-optical device. Here, light, such as external light or room illumination, incident to the reflection display region in each pixel, in which the reflecting film is formed, from an outside passes through the electro-optical material and is reflected by the reflecting film. And then, reflected light passes through the electro-optical material and is emitted as display light. Meanwhile, light incident to the transmission display region in each pixel, in which the reflecting film is not formed, for example, from a light source passes through the electro-optical material and is emitted as display light. Moreover, in order to prevent the external light or room illumination from being reflected to a display screen and to perform a more high quality image display, a scattering layer having an unevenness pattern is provided above or below the reflecting film in the reflection display region.

In this aspect in which the laminated structure includes the reflecting film, the laminated structure may further include a step forming film which is formed in the reflection display region.

Accordingly, the gap between the pair of substrates can be controlled in each of the reflection display region and the transmission display region by the means of the step forming film. Thus, the optical path length of light passing through the electro-optical material in the electro-optical device can be adjusted in each of the transmission display region and the reflection display region.

Here, the first columnar spacers may be provided in the reflection display region or may be provided in the transmission display region. In the case in which the first columnar spacers are provided in the reflection display region, the gap between the pair of substrates in the image display region is controlled by the means of the first columnar spacers and the step forming film. Meanwhile, in the case in which the first columnar spacers are provided in the transmission display region, the gap between the pair of substrates in the image display region is controlled only by the means of the first columnar spacers.

In this aspect in which the laminated structure includes the step forming film, the step forming film may be further formed outside the sealing region, and the second columnar spacers may be provided below or above the step forming film.

Accordingly, the gap in the peripheral region is controlled by the means of the step forming film and the second columnar spacers. Further, in addition to the step forming film, by forming the dummy film, the gap in the peripheral region may be adjusted. As a result, between the pair of substrates, the gap of the image display region is kept at a predetermined value by the means of the first columnar spacers or the first columnar spacers and the step forming film. At the same time, between the pair of substrates, the gap in the peripheral region is kept at a value different from that of the image display region, for example, at a value larger than that of the image display region, by the means of the second columnar spacers and the step forming film or the second columnar spacers, the step forming film and the dummy film. Therefore, according to this aspect, the first and second columnar spacers can be formed with spacers having the same height.

In order to solve the problems described above, there is provided an electronic apparatus comprising the electro-optical device described above (however, other various aspects are also included).

Since the electronic apparatus of the present invention comprises the electro-optical device of the present invention described above, various electronic apparatuses which can perform a high quality image display, such as a projection display device, a television, a cellular phone, an electronic organizer, a word processor, a view finder type or monitor-direct-view type video tape recorder, a workstation, a videophone, a POS terminal, a touch panel or the like, can be realized. Further, as the electronic apparatus of the present invention, for example, an electrophoretic device such as an electronic paper, an electron emission device (field emission display and conduction electron-emitter display), or a DLP (digital light processing) using the electrophoretic device or the electron emission device can be realized.

In order to solve the problems described above, there is provided a method of manufacturing an electro-optical device which comprises a pair of substrates with an electro-optical material interposed between, the pair of substrates being formed by cutting a pair of mother substrates for every panel forming region. The method of manufacturing an electro-optical device comprises a step of forming first columnar spacers inside a sealing region in each of a plurality of panel forming regions on at least one of the pair of mother substrates, a step of forming second columnar spacers outside the plurality of panel forming regions in a peripheral portion of the pair of mother substrates on at least one of the pair of mother substrates, and a step of forming a sealing material in the sealing region between the pair of mother substrates such that the first columnar spacers and the second columnar spacers are interposed therebetween, and bonding the pair of mother substrates.

According to the method of manufacturing an electro-optical device of the present invention, at least a portion outside the plurality of panel forming regions in the peripheral portion of the pair of mother substrates is cut off as a cutting margin.

And then, the gap between the pair of mother substrates is controlled by means of the first and second columnar spacers having different heights from each other. More specifically, the gap between the pair of mother substrates for every panel forming region is kept at a predetermined value by means of the first columnar spacers. At the same time, the gap between the pair of mother substrates in the peripheral portion of the pair of mother substrates outside the plurality of panel forming regions is kept at a value different from that of the panel forming region, for example, at a value larger than the predetermined value, by the means of the second columnar spacers. Thus, in the step of bonding the pair of mother substrates, even when the compression stress acts on the pair of mother substrates, the pair of mother substrates are prevented from being warped in a convex shape. In particular, even if the mother substrate slightly warps as the size thereof becomes large, the stress generated at the periphery may increase. Thus, providing the second columnar spacers having a large height or a high degree of strength at the periphery of the mother substrate is preferable.

Further, between the pair of mother substrates, the degree of strength of the first columnar spacers formed inside the sealing region of each of the panel forming regions and the degree of strength of the second columnar spacers formed in the peripheral portion of the pair of mother substrates are different. Here, since the mother substrate has the large size, the warps are larger. Thus, the stress acts more on the peripheral portion than on the central portion of the mother substrate. If the degree of strength of the second columnar spacers is sufficiently larger than that of the first columnar spacers between the pair of mother substrates, it is difficult to crush the second columnar spacers. Therefore, in the step of bonding the pair of mother substrates, even if the stress acts on the pair of mother substrates, the pair of mother substrates can be prevented from being warped in a convex shape.

Accordingly, in the electro-optical device which is manufactured by cutting the pair of mother substrates bonded to each other by means of the sealing material, gap spots in the pair of substrates with the electro-optical material interposed therebetween can be reduced. Thus, the unevenness in color can be prevented. Therefore, in the electro-optical device manufactured by the method of manufacturing an electro-optical device of the present invention, a high quality image display can be performed.

In an aspect of the method of manufacturing an electro-optical device of the present invention, the method further comprises a step of cutting and removing at least a portion of a region of the peripheral portion, in which the second columnar spacers are formed, from the electro-optical device.

According to this aspect, after the pair of mother substrates are bonded, at least the portion of the region of the peripheral portion of the pair of mother substrates, in which the second columnar spacers are formed, is cut off. Thus, the second columnar spacers formed in the peripheral portion of the pair of mother substrates can be removed from the respective panel forming regions. Moreover, in a portion of the mother substrate cut off as a cutting margin, the second columnar spacers are provided. Thus, with respect to the shape of the columnar spacer, various shapes such as a linear shape or a frame shape extending along the edge of the mother substrate may be used.

The operations and advantages of the present invention will be apparent from embodiments described below.

### BRIEF DESCRIPTION OF THE DRAWINGS

FIG. 1 is a plan view showing an entire configuration of an electro-optical device;

FIG. 2 is a cross-sectional view taken along the line H-H′ of FIG. 1;

FIG. 3 is an equivalent circuit diagram of various elements, wiring lines or the like in a plurality of pixels which is formed in a matrix type and constitutes an image display region of the electro-optical device;

FIG. 4 is a plan view of a group of a plurality of adjacent pixels on a TFT array substrate on which data lines, scanning lines, pixel electrodes or the like are formed;

FIG. 5 is a cross-sectional view taken along the line A-A′ of FIG. 4;

FIG. 6 is a plan view showing arrangement aspects of first and second columnar spacers on a counter substrate;

FIG. 7 is a cross-sectional view showing a configuration of the first and second columnar spacers;

FIGS. 8A and 8B are diagrams showing a cross-sectional configuration of the counter substrate sequentially in relation to steps of a manufacturing process;

FIGS. 9A and 9B are diagrams showing a cross-sectional configuration of a counter substrate sequentially in relation to steps of a manufacturing process in a modification;

FIG. 10 is a cross-sectional view showing a configuration of the first and second columnar spacers in the modification;

FIG. 11 is a cross-sectional view showing another configuration of the first and second columnar spacers in the modification;

FIG. 12 is a plan view showing an arrangement aspect of first and second columnar spacers according to a second embodiment;

FIG. 13 is a cross-sectional view showing a configuration of the first and second columnar spacers according to the second embodiment;

FIG. 14 is a partial plan view of a mother board;

FIG. 15 is a plan view showing an arrangement aspect of first and second columnar spacers according to a third embodiment;

FIG. 16 is a plan view showing a configuration of a projector as an example of an electronic apparatus to which a liquid crystal device is applied;

FIG. 17 is a perspective view showing a configuration of a personal computer as an example of an electronic apparatus to which a liquid crystal device is applied; and

FIG. 18 is a perspective view showing a configuration of a cellular phone as an example of an electronic apparatus to which a liquid crystal device is applied.

### DETAILED DESCRIPTION OF EMBODIMENTS

Hereinafter, embodiments of the present invention will be described with reference to the drawings. In the embodiments described below, a TFT active matrix driving type liquid crystal device having driving circuits is used as an example of the electro-optical device.

### 1: First Embodiment

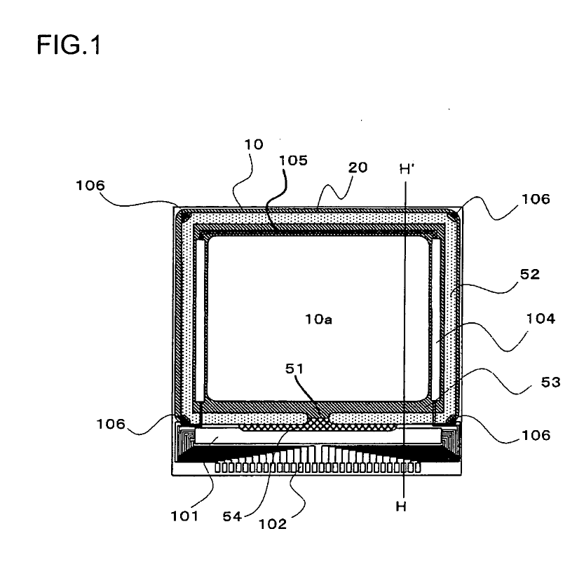

To begin with, a first embodiment of an electro-optical device according to the present invention will be described with reference to FIGS. 1 to 8.

<1-1: Configuration of Electro-Optical Device>

An entire configuration of the electro-optical device according to the present embodiment will be described with reference to FIGS. 1 to 3.

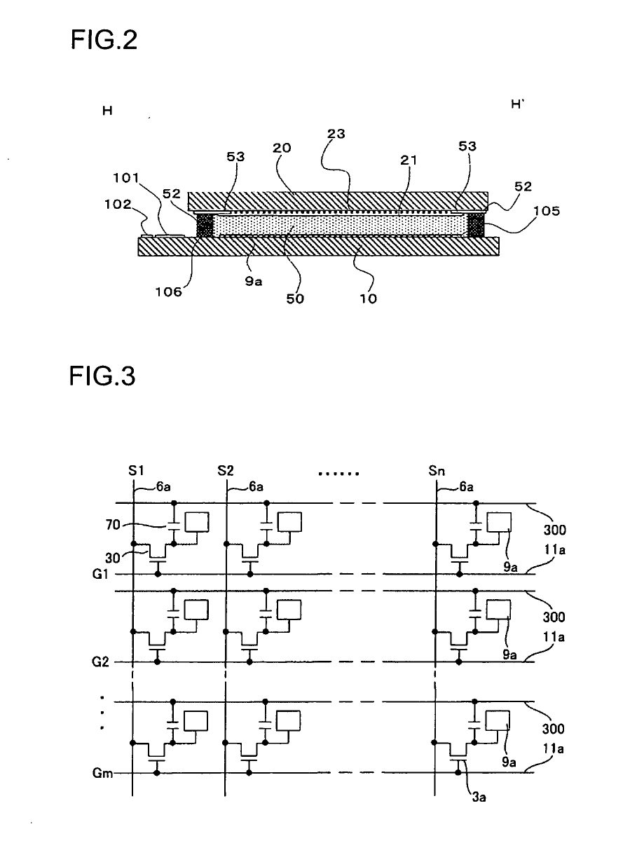

FIG. 1 is a plan view of a TFT array substrate and elements formed thereon, as seen from a counter substrate, and FIG. 2 is a cross-sectional view taken along the line H-H′ of FIG. 1. Further, FIG. 3 is an equivalent circuit diagram of various elements, wiring lines or the like in a plurality of pixels which is formed in a matrix type and constitutes an image display region of the electro-optical device. Moreover, hereinafter, in the respective drawings, to make each layer or each member to be sufficiently understandable size, each layer or each member is shown in a different reduced scale

Referring to FIGS. 1 and 2, in the electro-optical device according to the present embodiment, a TFT array substrate 10 and a counter substrate 20 are arranged to oppose each other. Between the TFT array substrate 10 and the counter substrate 20, a liquid crystal layer 50 is sealed. The TFT array substrate 10 and the counter substrate 20 are bonded to each other by means of a sealing material 52 which is provided at a sealing region around an image display region 10a.

Here, the liquid crystal layer 50 is made of, for example, liquid crystal material mixed with one or more nematic liquid crystal materials, and is aligned in a predetermined direction between a pair of the alignment films. The sealing material 52 for bonding the TFT array substrate 10 and the counter substrate 20 is made of, for example, an ultraviolet curable resin or a thermosetting resin. In a manufacturing process, the sealing material 52 is applied on the TFT array substrate 10, and then cured by means of ultraviolet irradiation or heating. In a portion of the sealing material 52, as shown in FIG. 1, a liquid crystal injection port 51 for injecting liquid crystal into a clearance interposed between the TFT array substrate 10 and the counter substrate 20 is provided. In the resultant electro-optical device, an end-sealing material 54 made of, for example, an ultraviolet curing acryl resin is provided in the liquid crystal injection port 51 such that the liquid crystal injected into the clearance is prevented from leaking outside.

Specifically, in the present embodiment, in order to keep a gap between the TFT array substrate 10 and the counter electrode 20 at a predetermined value in the image display region 10a, on counter electrodes 21 of the counter substrate 20, first and second columnar spacers, for example, having an approximately cylindrical shape (which are not shown in FIG. 2) are provided. Detailed descriptions of the first and second columnar spacers will be described below.

In FIG. 1, extending from an inner circumference of the sealing region, in which the sealing material 52 is arranged, to an outer circumference thereof, a frame light-shielding film 53 having a light-shielding property is consecutively provided on the counter substrate 20. By means of the frame light-shielding film 53 formed in the frame shape, a frame region of the image display region 10a is defined. However, a portion or an entire portion of the frame light-shielding film 53 may be built in the TFT array substrate 10.

In a region outside the sealing region, on which the sealing material 52 is arranged, among a peripheral region disposed around the image display region 10a, a data line driving circuit 101 and external circuit connecting terminals 102 are provided along a sideline of the TFT array substrate 10. Further, scanning line driving circuits 104 are provided along two sidelines adjacent to the sideline such that the scanning line driving circuits 104 are covered with the frame light-shielding film 53. In addition, to connect the two scanning line driving circuits 104 disposed at both sides of the image display region 10a, a plurality of wiring lines 105 are provided along a remaining sideline of the TFT array substrate 10 such that the plurality of wiring lines are covered with the frame light-shielding film 53.

In four corners of the counter substrate 20, vertically conducting materials 106, each functioning as a vertically conducting terminal between both substrates, are disposed. Further, in regions of the TFT array substrate 10 facing the corners, vertically conducting terminals are provided. With such a construction, the TFT array substrate 10 and the counter substrate 20 can electrically conducted with each other.

In FIG. 2, after TFTs (thin film transistors) for switching pixels or wiring lines such as scanning lines and data lines are formed on the TFT array substrate 10, an alignment film which is not shown in FIG. 2 is formed on pixel electrodes 9a. Meanwhile, on the counter substrate 20, in addition to the counter electrodes 21 made of a transparent material such as ITO (indium tin oxide), a light-shielding film 23 defining non-opened regions, or an alignment film, which is not shown in FIG. 2, formed on an uppermost layer are formed.

Moreover, on the TFT array substrate 10 shown in FIGS. 1 and 2, in addition to the data line driving circuit 101 and the scanning line driving circuits 104, a sampling circuit for sampling image signals on image signal lines and supplying the sampled image signals to the data lines, a precharge circuit for supplying a precharge signal having a predetermined voltage level to the data lines prior to the sampled image signals, a test circuit for testing a quality and defect of the electro-optical device during the manufacturing process or at the time of shipment may be formed.

Next, a circuit configuration and an operation in the electro-optical device configured in such a manner will be described with referent to FIG. 3.

In FIG. 3, in each of a plurality of pixels which is arranged in a matrix type and constitutes the image display region 10a of the electro-optical device in the present embodiment, a pixel electrode 9a and a TFT 30 for switching the pixel electrode 9a are formed, and a source of the TFT 30 is electrically connected to the data line 6a to which the image signal is supplied. The image signals S1, S2, . . . , Sn to be written in the data lines 6a may be sequentially supplied to the data lines 6a or may be supplied in a group to a plurality of adjacent data lines 6a.

Further, a gate of the TFT 30 is electrically connected to a gate electrode 3a, and thus scanning signals G1, G2, . . . , Gm are sequentially applied to the scanning lines 11a and the gate electrodes 3a at a predetermined time interval as a pulse. The pixel electrode 9a is electrically connected to a drain of the TFT 30, and by turning on the TFT 30 serving as a switching element for a predetermined period, the image signals S1, S2, . . . , Sn supplied from the data lines 6a are written in the pixel electrodes 9a at a predetermined time interval.

The image signals S1, S2, . . . , Sn of a predetermined level written in liquid crystal as an electro-optical material via the pixel electrodes 9a are held between the pixel electrode 9a and the counter electrode 21 formed on the counter substrate 20 for a predetermined period. An alignment or order of liquid crystal molecules changes according to an applied voltage level, and light is modulated, whereby gray scales can be displayed. In a normally white mode, for each pixel, transmittance with respect to incident light decreases according to the applied voltage. In a normally black mode, for each pixel, transmittance with respect to incident light increases according to the applied voltage. As a whole, light having the contrast which corresponds to the image signal is emitted from the electro-optical device.

Here, in order to prevent the held image signal from leaking, storage capacitors 70 are added parallel to liquid crystal capacitors which are formed between the pixel electrodes 9a and the counter electrodes 21. The storage capacitors 70 are provided parallel to the scanning lines 11a, each having a fixed potential capacitor electrode and a capacitor electrode 300 which is fixed to a constant potential.

Moreover, in the present embodiment, three pixel portions of a red (R) pixel portion, a green (G) pixel portion and a blue (B) pixel portion are included in the image display region 10a. By means of three pixel portions, a color display is performed.

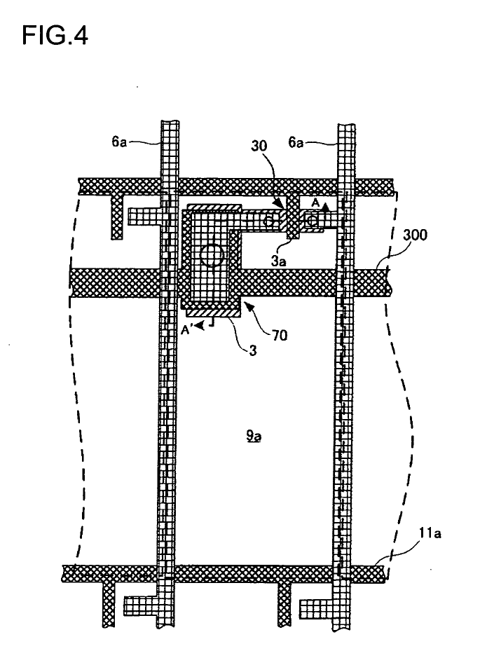

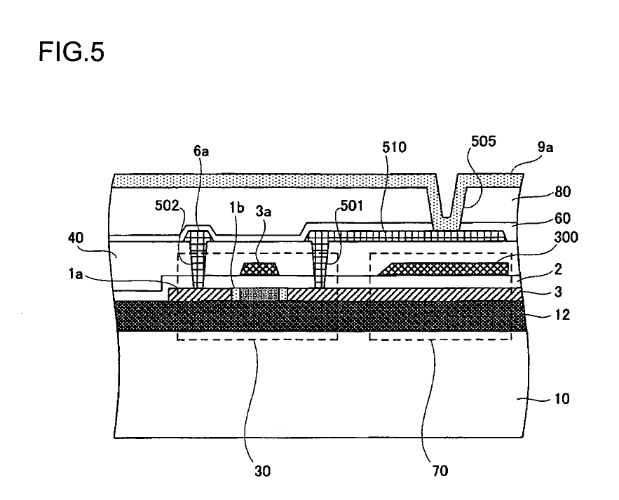

Subsequently, hereinafter, a configuration of the pixel portion in the electro-optical device of the present embodiment will be described. First, a configuration on the TFT array substrate 10 will be described with reference to FIGS. 4 and 5.

FIG. 4 is a plan view of a group of a plurality of adjacent pixels on a TFT array substrate on which data lines, scanning lines, pixel electrodes or the like are formed, and FIG. 5 is a cross-sectional view taken along the line A-A′ of FIG. 4.

In FIG. 5, the TFT array substrate 10 is made of an insulating transparent substrate such as a glass substrate. On the TFT array substrate 10, for example, a silicon oxide film (SiO₂) is formed as a base insulating film 12. The film thickness of the base insulating film 12 is preferably set in a range of from 500 [nm] to 1000 [nm]. On the base insulating film 12, the TFT 30 and the storage capacitor 70 are formed.

In FIGS. 4 and 5, the TFT 30 comprises a semiconductor film 3 made of a polysilicon film, for example, at a film thickness in a range of from 20 [nm] to 100 [nm] on the base insulating film 12, a gate oxide film 2 made of, for example, a silicon oxide film (SiO₂) at a film thickness in a range of from 50 [nm] to 100 [nm] to cover the semiconductor film 3, and a gate electrode 3a made of a conductive material mainly containing, for example, aluminum (Al), tungsten (Ta) and molybdenum (Mo) corresponding to the semiconductor film 3 on the gate oxide film 2. In the semiconductor film 3, low-doped regions 1b are formed with a channel region of the TFT 30 interposed therebetween, and high-doped regions 1a are formed adjacent to the low-doped regions 1b. That is, the TFT 30 shown in FIG. 5 has an LDD (lightly doped drain) structure.

Further, in FIGS. 4 and 5, the storage capacitor 70 has a lower electrode which is formed by a portion of the high-doped region 1a in the semiconductor film 3 and the capacitor electrode 300 which is formed on the gate oxide film 2 and serves as a fixed potential capacitor electrode.

Here, preferably, the capacitor electrode 300 and the scanning line 11a are formed with the same conductive film as that of the gate electrode 3a. Moreover, the film thickness of the conductive film constituting the gate electrode 3a, the scanning line 11a and the capacitor electrode 300 is preferably in a range of from 300 [nm] to 600 [nm].

In FIG. 5, a first interlayer insulating film 40 made of, for example, a silicon oxide film (SiO₂) is formed at a film thickness in a range of from 500 [nm] to 1000 [nm] to cover the gate electrode 3a, the scanning line 11a, which is not shown, and the capacitor electrode 300. In the first interlayer insulating film 40, contact holes 501 and 502 which pass through the first interlayer insulating film 40 and the gate oxide film 2 and extend from the surface of the first interlayer insulating film 40 to surfaces of the high-doped regions 1a in the semiconductor film 3 are formed. And then, the contact holes 501 and 502 are covered with a conductive material mainly containing, for example, aluminum (Al), such that the data line 6a which is electrically connected to a source of the TFT 30 and a drain electrode 510 are formed on the first interlayer insulating film 40. The film thickness of each of the data line 6a and the drain electrode 510 is preferably formed in a range of from 400 [nm] to 700 [nm]

Further, on the first interlayer insulating film 40, a silicon oxide film is formed to have a thickness, for example, in a range of from 100 [nm] to 200 [nm] as a second interlayer insulating film 60. In addition, on the second interlayer insulating film 60, a third interlayer insulating film 80 is formed with a photosensitive organic resin material such as an acryl film at a film thickness in a range of from 1 [μm] 2 [μm].

Further, a contact hole 505 which passes through the second and third interlayer insulating films 60 and 80 and extends from a surface of the third interlayer insulating film 80 to a surface of the drain electrode 510 is opened. The contact hole 505 is covered with a conductive material such as ITO (indium tin oxide), such that the pixel electrode 9a is formed corresponding to an opened region of the pixel portion, as shown in FIG. 4.

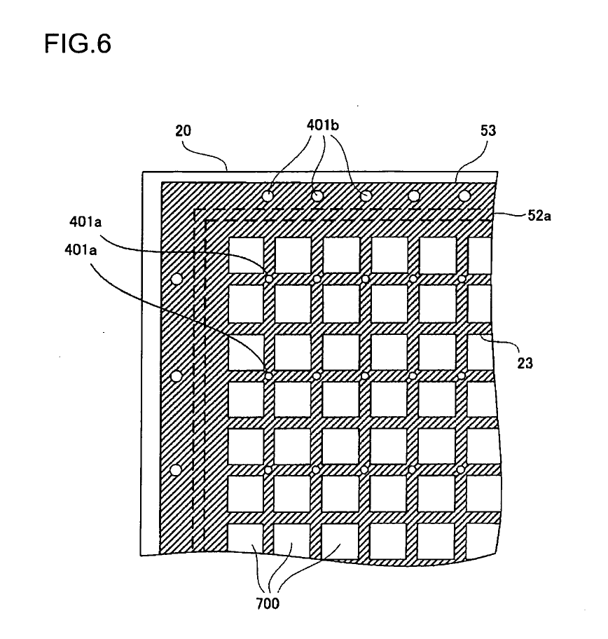

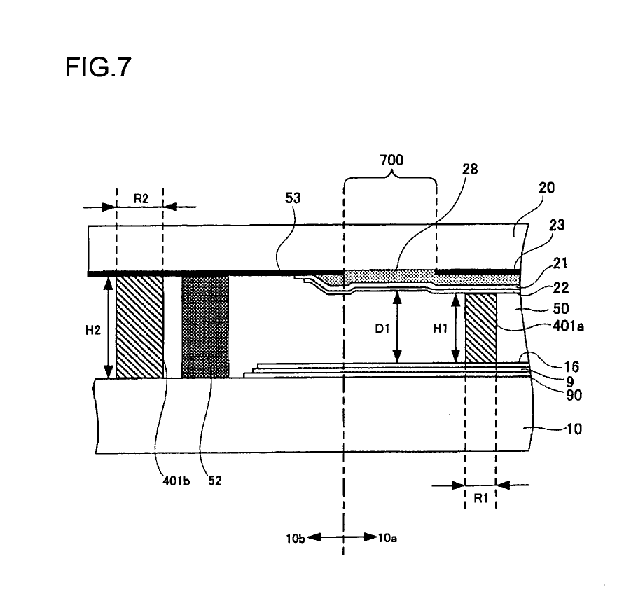

Next, a configuration on the counter substrate 20 will be described with referent to FIGS. 6 and 7.

Here, FIG. 6 is a plan view showing arrangement aspects of first and second columnar spacers on the counter substrate 20. Further, FIG. 7 shows a portion of the sectional configuration shown in FIG. 2 in detail, so as to illustrate a configuration of the first and second columnar spacers.

In FIGS. 6 and 7, on the counter substrate 20, the frame light-shielding film 53, and the light-shielding film 23 extending consecutively from the frame light-shielding film 53 and having a lattice-shape planar pattern as shown in FIG. 6, for example, are formed. In the counter substrate 20, the non-opened regions are defined by the light-shielding film 23, and regions divided by the light-shielding film 23 become opened regions 700. Moreover, the non-opened regions may be defined by the light-shielding film 23 formed in a stripe shape and various elements such as the data lines 6a provided on the TFT array substrate 10.

In the present embodiment, as shown in FIG. 7, a colored layer 28 is formed in a region which includes portions of the non-opened region and the opened region at a lower side of the counter substrate 20. The colored layer 28 is provided for every color in correspondence with the R pixel portion, the G pixel portion and the B pixel portion. Further, the counter electrode 21 made of a transparent conductive film is formed to cover the colored layer 28 and the light-shielding film 23, and an alignment film 22 is formed below the counter electrode 21.

Meanwhile, in FIG. 7, on the TFT array substrate 10, a laminated structure 90 including various films, such as the semiconductor film 3, which are described above with reference to FIGS. 4 and 5, is formed. On the laminated structure 90, a transparent conductive film 9 constituting the pixel electrode 9a is formed. And then, on the transparent conductive film 9, an alignment film 16 is provided.

Moreover, the TFT 30, various wiring lines such as the scanning line 11a or the data line 6a for driving the pixel electrode 9a, and electronic elements such as the storage capacitor 70 are arranged in the non-opened region. Thus, a pixel aperture ratio in the electro-optical device can be kept relatively large. Further, in the sealing region on which the sealing material 52 is arranged, as shown in FIG. 7, preferably, the laminated structure 90 is not formed and the sealing material 52 is directly adhered to the TFT array substrate 10. Accordingly, the counter substrate 20 and the TFT array substrate 10 can be bonded via the sealing material 52 more stably.

In the present embodiment, as described above, the first and second columnar spacers 401a and 401b having the approximately cylindrical shape are provided. The first and second columnar spacers 401a and 401b are made of, for example, a material such as an acryl resin or polyimide. Moreover, the first and second columnar spacers 401a and 410b are not limited to the approximately cylindrical shape, but they may be in an approximately cube shape or rectangular parallelepiped shape.

As shown in FIGS. 6 and 7, the first columnar spacers 401a are provided below the light-shielding film 23 in the image display region 10a by one per one or two pixel portions. In FIG. 6, a configuration in which the first columnar spacers 401a are provided by one per two pixel portions is shown. In such a manner, the first columnar spacers 401a are arranged below the light-shielding film 23, that is, in the non-opened regions which do not contribute to the image display. Thus, display light does not scatter by the first columnar spacers 401a. As a result, display quality in each pixel can be prevented from being deteriorated.

Further, the second columnar spacers 401b are provided below the frame light-shielding film 53 outside the sealing region 52a of the peripheral region 10b. Moreover, the second columnar spacers 401b are not limited to the configuration in which they are arranged below the frame light-shielding film 53, but they may be arranged at positions outside the sealing regions 52a.

In the present embodiment, it is assumed that the gap D1 between the TFT array substrate 10 and the counter substrate 20 in the image display region 10a is kept, for example, at 4 [μm] by means of the first and second columnar spacers 401a and 401b. Here, as shown in FIG. 7, between the TFT array substrate 10 and the counter substrate 20, the step is generated in the image display region 10a and the peripheral region 10b in the substrate surface. The reason why the step is generated is as follows.

That is, in FIG. 7, when the laminated structure in the image display region 10a compares with that in the peripheral region 10b on the counter substrate 20, it can be seen that the colored layer 28, the counter electrode 21 and the alignment 22 are formed in the image display region 10a. Among these films, the colored layer 28 is formed with a relatively thick film to have a film thickness, for example, reaching 1 [μm]. Thus, primarily due to the colored layer 28, the step is generated in the image display region 10a and the peripheral region 10b in the substrate surface on the counter substrate 20.

Meanwhile, in the image display region 10a and the peripheral region 10b on the TFT array substrate 10, it can be seen that the laminated structure 90, the transparent conductive film 9 and the alignment film 16 are formed in the image display region 10a. Thus, on the TFT array substrate 10, the step is also generated in the image display region 10a and the peripheral region 10b in the substrate surface.

Thus, the gap between the TFT array substrate 10 and the counter substrate 20 is relatively larger in the peripheral region 10b than in the image display region 10a. In the present embodiment, the first columnar spacers 401a and the second columnar spacers 401b are formed to have different heights from each other. More specifically, the height H1 of the first columnar spacer 401a is set to, for example, 4 [μm] and the height H2 of the second columnar spacers 401b is set to, for example, 4.5 [μm].

In the present embodiment, the second columnar spacers 401b are formed to have the height such that the steps generated in the substrate surface between the TFT array substrate 10 and the counter substrate 20 are adjusted by means of the second columnar spacers 401b as described above. Thus, the steps generated in the substrate surface between the TFT array substrate 10 and the counter substrate 20 are substantially compensated by means of the second columnar spacers 401b. Therefore, the second columnar spacers 401b can be prevented from floating.

Thus, in a manufacturing process of the electro-optical device, for example, in the step of bonding the TFT array substrate 10 and the counter substrate 20 or the liquid crystal injection step, even if the compression stress acts on the TFT array substrate 10 and the counter substrate 20, the TFT array substrate 10 and the counter substrate 20 can be prevented from being warped in the convex shape by means of the first and second columnar spacers 401a and 401b.

In addition, in the present embodiment, the first columnar spacers 401a and the second columnar spacers 401b have the sectional areas different from each other when being cut in a direction orthogonal to a height direction thereof. More specifically, the diameter R1 of the sectional area when the first columnar spacer 401a is cut in the direction orthogonal to the height direction thereof is set to, for example, 12 [μm]. Further, the diameter R2 of the sectional area when the second columnar spacer 401b is cut in the direction orthogonal to the height direction thereof is set to, for example, 20 [μm]. Thus, between the TFT array substrate 10 and the counter substrate 20, the degree of strength of the second columnar spacer 401b in the peripheral region 10b can be relatively larger than that of the first columnar spacer 401a in the image display region 10a. Therefore, in the manufacturing process of the electro-optical device, even if the compression stress acts on the TFT array substrate 10 and the counter substrate 20 and the peripheral region 10b is drastically pressed as compared to the central portion of the image display region 10a, it is difficult to crush the second columnar spacers 401b. Therefore, the second columnar spacers 401b are not crushed, and thus the TFT array substrate 10 and the counter substrate 20 can be prevented from being warped in the convex shape.

Thus, according to the present embodiment, since the gap spots are reduced in the image display region 10a, the unevenness in color can be prevented from being caused at the time of the image display. As a result, in the electro-optical device of the present embodiment, a high quality image display can be performed. Moreover, the gap between the TFT array substrate 10 and the counter substrate 20 may be controlled by beadlike spacers which are distributed into the liquid crystal layer 50 or the sealing material 52, in addition to the first and second columnar spacers 401a and 401b.

<1-2: Method of Manufacturing Electro-Optical Device>

A method of manufacturing the above-mentioned electro-optical device will now be described with reference to FIGS. 4 to 8.

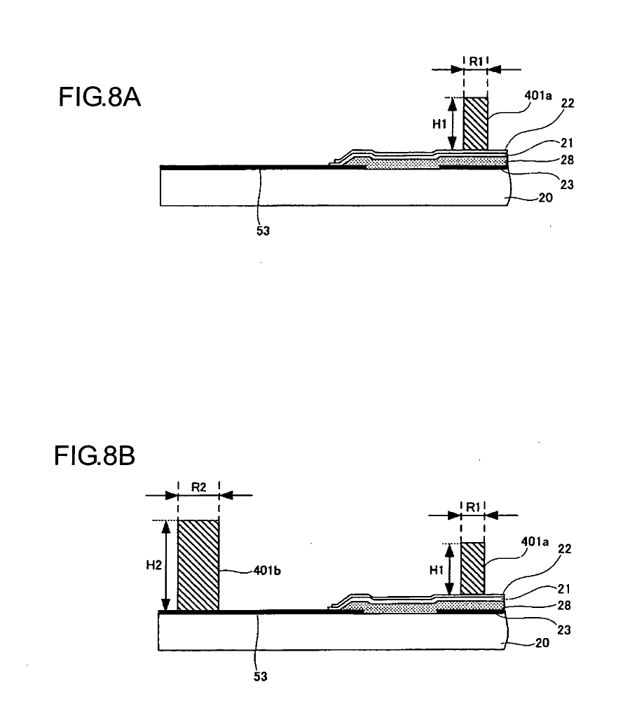

Here, FIG. 8 is a diagram showing a cross-sectional configuration of the counter substrate 20 shown in FIG. 7 sequentially in relation to steps of a manufacturing process.

To begin with, a manufacturing process on the TFT array substrate 10 will be described with reference to FIGS. 4 and 5. Moreover, hereinafter, the TFT 30 is manufactured as an N-channel type transistor, but the TFT 30 is not limited to the N-channel type transistor. Alternatively, the TFT 30 may be manufactured as a P-channel type transistor.

First, the base insulating film 12 is film-formed on the TFT array substrate 10 by means of, for example, the plasma CVD (chemical vapor deposition) method, and then the semiconductor film 3 is formed. The semiconductor film 3 is film-formed on the base insulating film 12 and activated by means of the laser, and then the semiconductor film 3 is patterned by means of a fine processing method.

Next, the gate oxide film 2 is film-formed by means of, for example, the plasma CVD method. Subsequently, a resist is formed on the gate oxide film 2 to cover surfaces of the channel region and the low-doped regions 1b in the semiconductor film 3. And then, for example, phosphorus (P) ions as an impurity are injected into the high-doped regions 1a of the semiconductor film 3 with an injection amount in a range of from 1×10¹⁵ [ions/cm²] to 1×10¹⁶ [ions/cm²] via the gate oxide film 2 by means of an ion doping method.

Next, the resist is removed, and then a conductive film which is film-formed by a sputtering method is patterned by means of the fine processing method, such that the gate electrode 3a, the scanning line 11a and the capacitor electrode 300 are formed. Subsequently, with the gate electrode 3a or the like as a mask, for example, phosphorus (P) ions as an impurity are injected into the semiconductor film 3 with an injection amount in a range of from 1×10¹³ [ions/cm²] to 1×10¹⁴ [ions/cm²] via the gate oxide film 2 by means of the ion doping method. Thus, the low-doped regions 1b are formed in the semiconductor film 3.

Next, the first interlayer insulating film 40 is film-formed by means of, for example, the plasma CVD method and patterned by means of the fine processing method. And then, the contact holes 501 and 502 are opened by means of the dry etching method. Subsequently, a conductive film is film-formed to cover the contact holes 501 and 502 by means of, for example, the sputtering method, such that the data line 6a and the drain electrode 510 are formed.

Next, the second interlayer insulating film 60 is film-formed by means of, for example, the plasma CVD method and further the third interlayer insulating film 80 is formed by means of a spin coating method. Subsequently, the third interlayer insulating film 80 is developed by means of, for example, the photography method, and then the second interlayer insulating film 60 is etched by means of, for example, the dry etching method, such that the contact hole 505 is opened.

Next, a transparent conductive film is formed by means of, for example, the sputtering method and patterned, such that pixel electrode 9a is formed.

A manufacturing process on the counter substrate 20 will now be described with referent to FIGS. 6 to 8.

First, the light-shielding film is film-formed on the counter substrate 20 and patterned, such that the frame light-shielding film 53 and the light-shielding film 23 are film-formed. And then, the colored layer 28 is formed for every color.

Next, a transparent conductive film is film-formed by means of, for example, the sputtering method and patterned, such that the counter electrode 21 is formed. Subsequently, the alignment film 22 is formed.

Next, in FIG. 8(a), a photosensitive resin material is coated at a thickness, for example, in a range of 2 [μm] 6 [μm] and developed by means of, for example, the photolithography method. Accordingly, the first columnar spacer 401a is formed.

Next, in FIG. 8(b), a photosensitive resin material is coated at a thickness, for example, in a range of 5 [μm] 9 [μm] and, similarly to the sequence described with reference to FIG. 8(a), the second columnar spacer 401b is formed. Moreover, when the diameter R1 of the first columnar spacer 401a is set to 12 [μm], the diameter R2 of the second columnar spacer 401b is set to 20 [μm]. Thus, the second columnar spacer 401b having the sufficient degree of strength can be secured.

Next, after bonding the TFT array substrate 10 and the counter substrate 20 by means of the sealing material 52, the liquid crystal injection step is performed, such that the electro-optical device is manufactured.

<1-3: Modification>

A modification of the present embodiment will be described below. The first and second columnar spacers 401a and 401b described with reference to FIG. 8 may be manufactured as follows.

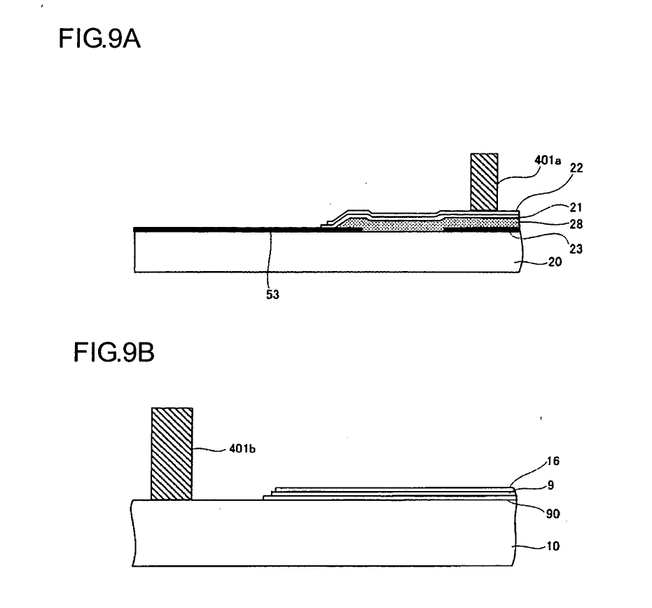

FIG. 9 is a diagram showing a cross-sectional configuration of the counter substrate 20 shown in FIG. 7 sequentially in relation to steps of a manufacturing process when the first and second columnar spacers 401a and 401b are manufactured according to the present modification.

In FIG. 9A, on the counter substrate 20 on which the frame light-shielding film 53, the light-shielding film 23, the colored layer 28 and so on are formed, in the same sequence as that in FIG. 8(a), the first columnar spacer 401a is formed.

In FIG. 9B, on the TFT array substrate 10 on which the laminated structure 90, the transparent conductive film 9 and so on are formed, in the same sequence as that in FIG. 8(b), the second columnar spacer 401b is formed.

In addition, the first and second columnar spacers 401a and 401b may be formed on the TFT array substrate 10. Alternatively, the second columnar spacer 401b may be formed on the counter substrate 20 and the first columnar spacer 401a may be formed on the TFT array substrate 10.

In addition, the first and second columnar spacers 401a and 401b may be configured as follows.

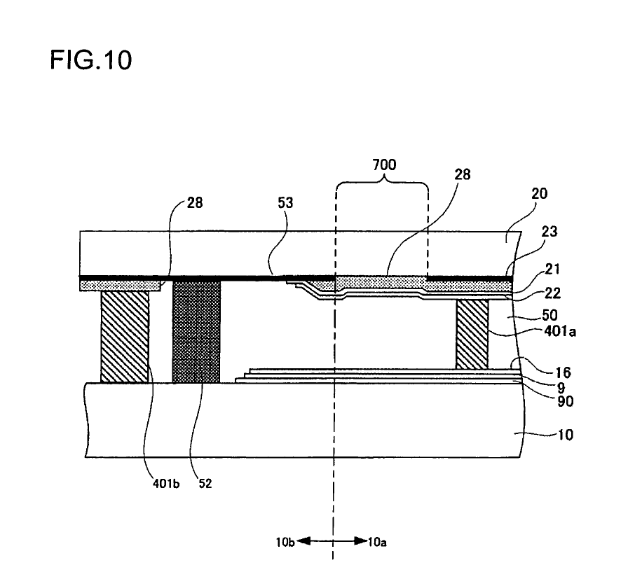

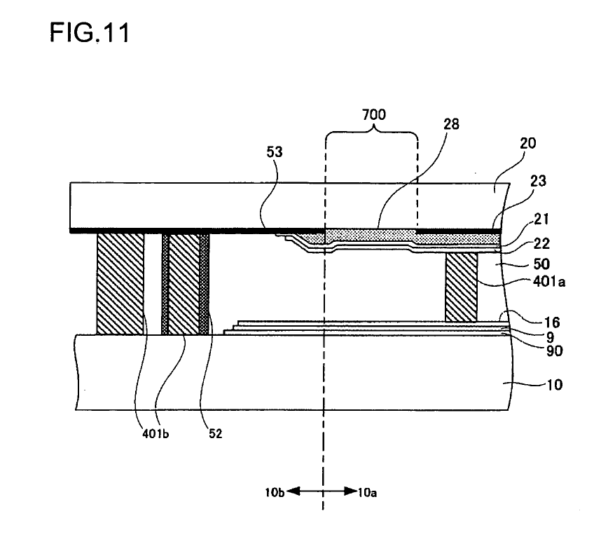

FIG. 10 shows a configuration of the first and second columnar spacers in the present modification, which is a cross-sectional view similar to FIG. 7. FIG. 11 shows another configuration of the first and second columnar spacers 401a and 401b in the present modification, which is a cross-sectional view similar to FIG. 7.

As shown in FIG. 10, the colored layer 28 may be provided as a dummy layer outside the sealing region, for example, on the counter electrode 20 such that the height of the second columnar spacer 401b is adjusted. In FIG. 10, the second columnar spacer 401b is arranged below the colored layer 28 outside the sealing region. In such a manner, by adjusting the height of the second columnar spacer 401b, the step generated in the substrate surface between the TFT array substrate 10 and the counter substrate 20 is compensated by the second columnar spacer 401b, such that the second columnar spacer 401b does not float. Further, by forming the dummy layer with the same film as the film which is included in the laminated structure formed on the counter substrate 20, the dummy layer can be formed more easily. Moreover, the dummy layer may be formed on the TFT array substrate 10 and the second columnar spacer 401b may be arranged on the dummy film. Further, the dummy film may be formed in the TFT array substrate 10 and the counter substrate 20 such that the height of the second columnar spacer 401b is adjusted.

Further, as shown in FIG. 11, the second columnar spacer 401b of which the height itself is adjusted may be arranged in the sealing region. In this case, the gap between the TFT array substrate 10 and the counter substrate 20 in the image display region 10a can be controlled by the first and second columnar spacers 401a and 401b.

In addition, the first and second columnar spacers 401a and 401b may be formed to have different formation densities. For example, the first columnar spacers 401a may be formed by one per three pixel portions of the red pixel portion, the green pixel portion and the blue pixel portion, for example, by one per 100 [μm]×100 [μm] or may be provided by one per nine pixel portion including three red pixel portions, three green pixel portions and three blue pixel portions, for example, by one per 300 [μm]×300 [μm]. Further, the second columnar spacers 401b may be provided by nine or ten per one first columnar spacer 401a. Thus, the degree of strength of the first columnar spacer 401a in the image display region 10a and the degree of strength of the second columnar spacer 401b in the peripheral region 10b between the TFT array substrate 10 and the counter substrate 20 may have different values from each other. Thus, the warpage in the TFT array substrate 10 and the counter substrate 20 bonded by means of the sealing material 52 is reduced, such that the gap spots in the image display region 10a can be reduced.

### 2: Second Embodiment

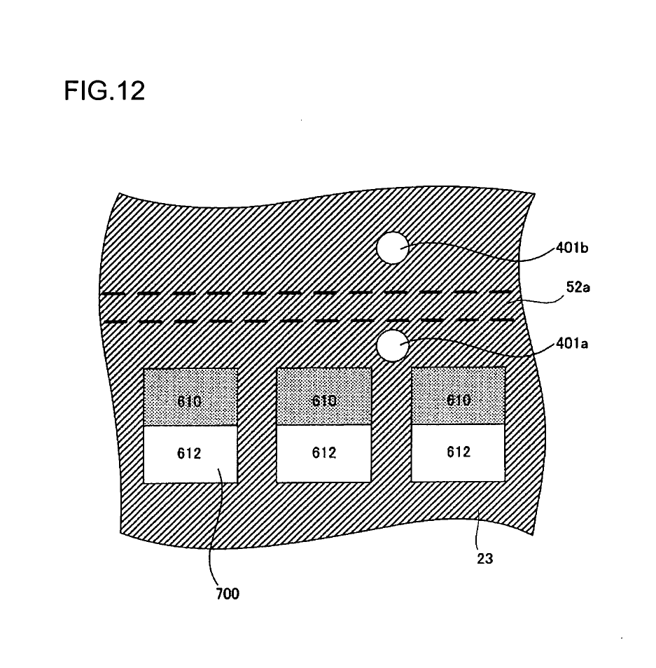

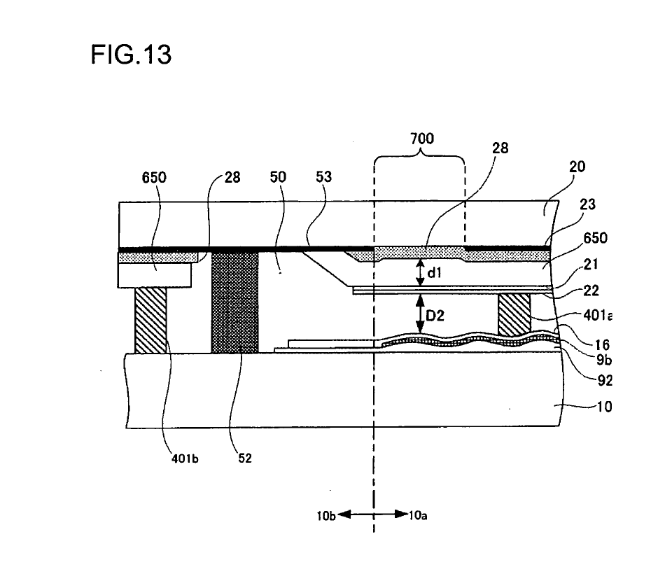

A second embodiment of an electro-optical device according to the present invention will now be described. In the second embodiment, a configuration of a pixel portion is different from that in the first embodiment. Thus, only different elements from those in the first embodiment will be described in detail with reference to FIGS. 12 to 13.

Here, FIG. 12 is a plan view showing an arrangement aspect of first and second columnar spacers according to the second embodiment. Further, FIG. 13 shows a cross-sectional configuration for illustrating a configuration of the first and second columnar spacers, which corresponds to FIG. 7. Moreover, in FIGS. 12 and 13, the same reference numerals as those in the first embodiments represent the same elements, and the descriptions of the same elements will be omitted.

The electro-optical device of the second embodiment is configured as a transflective electro-optical device. In FIG. 12, configurations of a portion of the light-shielding film 53 which is formed consecutively from an outside of the sealing region 52a to an inside of the sealing region 52a in the peripheral region, and a portion of the light-shielding film 23 in the image display region 10a, which is formed consecutively to the frame light-shielding film 53 are shown. Each of the opened regions 700 divided by the light-shielding film 23 is split into a reflection display region 610 and a transmission display region 612.

In the reflection display region 610, as shown in FIG. 13, a reflecting electrode 9b is formed on a laminated structure 92 including a scattering layer, of which surface has an unevenness pattern, on the TFT array substrate 10. More specifically, for example, in the surface of the third interlayer insulating film 80 shown in FIG. 5, the unevenness pattern is formed in the reflection display region 610, such that the third interlayer insulating film 80 serves as the scattering layer. And then, on the unevenness pattern of the third interlayer insulating film 80, the reflecting electrode 9b is formed with a material such as aluminum (Al) or silver (Ag).

Meanwhile, in the transmission display region 612, the configuration on the TFT array substrate 10 is the same as that shown in FIG. 5 or 7, in which the transparent conductive film 9 is formed on the laminated structure 90.

Further, in the reflection display region 610 on the counter substrate 20, a step forming film 650 made of, for example, an acryl-based resin or polyimide is formed below the colored layer 28 as shown in FIG. 13. Moreover, the step forming film 650 may be formed on the TFT array substrate 10.

The gap between the TFT array substrate 10 and the counter substrate 20 is adjusted to have a different value in the reflection display region 610 and the transmission display region 612 by means of the step forming film 650. In the second embodiment, the gap between the TFT array substrate 10 and the counter substrate 20 in the transmission display region 612 is set to, for example, 4 [μm]. Further, it is assumed that, in the reflection display region 610, the gap D2 between the TFT array substrate 10 and the counter substrate 20 is adjusted to, for example, 2 [μm] by means of the step forming film 650 having a film thickness d1 of, for example, 2 [μm].

At the time of the operation of the electro-optical device, incident light, such as external light or room illumination, from an outside to the reflection display region 610 passes through the liquid crystal and is reflected by the reflecting electrode 9b. Reflected light passes through the liquid crystal and is emitted as display light. Thus, by forming the step forming film 650 in the reflection display region 610, an optical path length of light passing through the liquid crystal can be adjusted in the transmission display region 612 and the reflection display region 610.

Further, in the second embodiment, the first columnar spacer 401a is arranged on the reflection display region 610 below the light-shielding film 23 of the image display region 10a, as shown in FIGS. 12 and 13. Moreover, the first columnar spacer 401a may be arranged on the transmission display region 612 below the light-shielding film 23 of the image display region 10a.

Thus, the gap between the TFT array substrate 10 and the counter substrate 20 is controlled by means of the first columnar spacer 401a and the step forming film 650 in the image display region 10a. More specifically, by means of the first columnar spacer 401a having a height of, for example, 2 [μm] and the step forming film 650, the gap D2 between the TFT array substrate 10 and the counter substrate 20 in the reflection display region 610 is kept to, for example, 2 [μm]. Accordingly, the gap between the TFT array substrate 10 and the counter substrate 20 in the transmission display region 612 is kept to, for example, 4 [μm]

Meanwhile, as shown in FIG. 13, the gap between the TFT array substrate 10 and the counter substrate 20 has a different value in the image display region 10a and the peripheral region 10b. In particular, the gap between the TFT array substrate 10 and the counter substrate 20 has a more largely different value in the reflection display region 610 of each pixel portion and the peripheral portion 10b.

Here, as shown in FIG. 13, the step forming film 650 and the colored layer 28 are also formed as the dummy layer outside the sealing region. And then, in FIG. 13, the second columnar spacer 401b is arranged below the step forming film 650 and the colored layer 28 serving as the dummy film, and thus the height of the second columnar spacer 401b is adjusted to 4.5 [μm]. By using such a second columnar spacer 401b, the step in the substrate surface between the TFT array substrate 10 and the counter substrate 20 is compensated, such that the second columnar spacer 401b does not float. Moreover, only the step forming film 650 may be used as the dummy film. Further, in addition to the step forming film 650, a plurality of layers, including the colored layer 28, may be formed as the dummy film.

Thus, in the second embodiment, the warpage of the TFT array substrate 10 and the counter substrate 20 which are bonded by means of the sealing material 52 is reduced, and thus the gap spots in the image display region 10a can be reduced. Further, in the second embodiment, the first and second columnar spacers 401a and 401b can be formed with spacers having the same height.

A method of manufacturing the above-mentioned electro-optical device of the second embodiment will be described with reference to FIGS. 5, 12 and 13. Hereinafter, only different elements from those in the first embodiment will be described.

On the TFT array substrate 10, the unevenness pattern is formed in the surface of the third interlayer insulating film 80 with a mask by means of, for example, the photolithography method.

Further, the transparent conductive film is formed in the transmission display region 612, and the reflecting electrode 9b is formed in the reflection display region 610 by means of, for example, the sputtering method, such that the pixel electrode 9a is formed.

Meanwhile, on the counter substrate 20 on which the frame light-shielding film 53, the light-shielding film 23 and the colored layer 28 are formed, a photosensitive resin material is coated at a thickness, for example, in a range of from 1 [μm] to 4 [μm] and is developed by means of, for example, the photolithography method. Accordingly, the step forming film 650 is formed.

Next, in the same sequence as that in the first embodiment, the counter electrode 21, the alignment film 22, and the first and second columnar spacers 401a and 401b are formed.

### 3: Third Embodiment

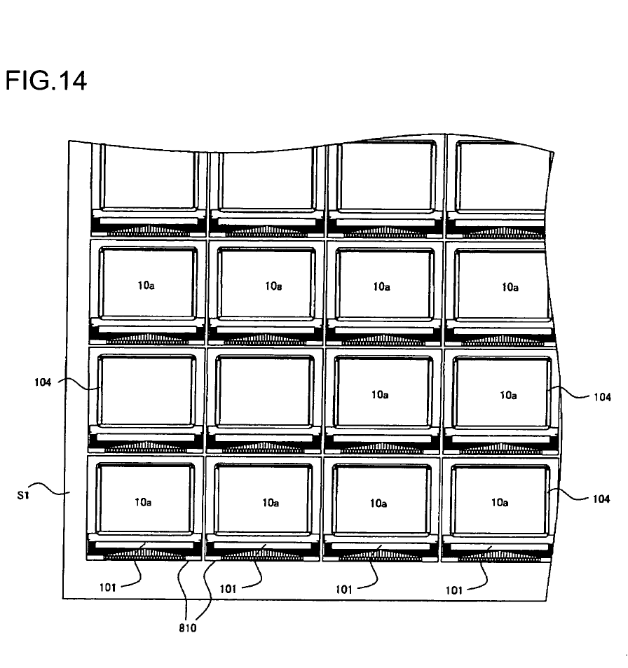

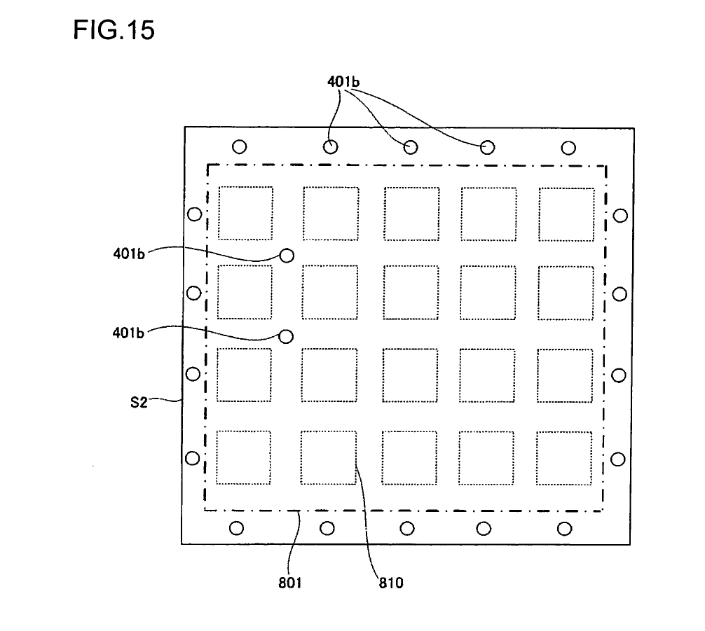

A third embodiment of a method of manufacturing an electro-optical device according to the present invention will be described with reference to FIGS. 14 and 15. Hereinafter, only different elements from those in the first or second embodiment will be described.

Here, FIG. 14 is a partial plan view illustrating a case in which a plurality of electro-optical devices are formed on a mother board having a relatively large size by one effort. Further, FIG. 15 is a plan view showing an arrangement aspect of first and second columnar spacers according to a third embodiment. Moreover, in FIGS. 14 and 15, the same reference numerals as those in the first and second embodiments represent the same elements, and the descriptions of the same elements will be omitted.

Hereafter, the process of bonding the two mother substrates which is characteristic of the present embodiment will be described in detailed.

In the third embodiment, as shown in FIG. 14, a laminated structure including various elements (the TFT 30, the storage capacitor 70 or the scanning line driving circuit 104 or the data line driving circuit 101, and so on) on the TFT array substrate 10 shown in FIGS. 1 and 2 and FIGS. 4 and 5 is formed for every panel forming region 810 on a mother substrate S1. Meanwhile, on an additional mother substrate S2 shown in FIG. 15, a laminated structure including various elements (the counter electrode 21 or the colored layer 28 and so on) on the counter substrate 20 shown in FIGS. 1 and 2 and FIGS. 6 and 7 is formed for every panel forming region 810. And then, finally, the mother substrate S1 shown in FIG. 14 and the mother substrate S2 shown in FIG. 15 oppose each other to be bonded, and then the liquid crystal is sealed between the mother substrates S1 and S2. In addition, each panel forming region 810 is cut off, and then the electro-optical device as shown in FIGS. 1 and 2 is respectively manufactured.

Here, in FIG. 15, a plurality of panel forming regions 810 are provided inside a sealing region 801. And then, on the mother substrate S2, similarly to the first or second embodiment, the first columnar spacer 401a (see FIG. 7 or 13) is formed for every panel forming region 810. Further, outside the sealing region 801 in the mother substrate S2, that is, outside the plurality of panel forming regions 810 in a peripheral portion of the mother substrate S2, the second columnar spacers 401b are formed. Alternatively, as shown in FIG. 15, inside the sealing region 801 and outside the respective panel forming region 810, the second columnar spacers 401b may be arranged.

The pair of mother substrates S1 and S2 are bonded such that the first and second columnar spacers 401a and 401b are interposed between the pair of mother substrates S1 and S2. The first and second columnar spacers 401a and 401b are formed to have different heights from each other, such that the step generated in the substrate surface between two mother substrates S1 and S2 is compensated by means of the second columnar spacers 401b and the second columnar spacers 401b do not float. Thus, in a step of bonding the pair of mother substrates S1 and S2, even if the compression stress acts on the mother substrates S1 and S2, the mother substrates S1 and S2 can be prevented from being warped by means of the first and second columnar spacers 401a and 401b.

Further, between the pair of mother substrates S1 and S2, the degree of strength of the first columnar spacer 401a and the degree of strength of the second columnar spacer 401b may have different values from each other. More specifically, as previously described in the first or second embodiment, the first columnar spacer 401a and the second columnar spacer 401b may be formed to have different sectional areas from each other or may be formed to have different formation densities from each other.

Here, since the mother substrates S1 and S2 have a large size, they warp greatly. Thus, the stress acts more greatly on the peripheral portion than on the central portion of the mother substrates S1 and S2. If the degree of strength of the second columnar spacer 401b is sufficiently larger than that of the first columnar spacer 401a between the pair of mother substrates S1 and S2, it is difficult to crush the second columnar spacer 401b. Therefore, in a step of bonding the pair of mother substrates S1 and S2, even if the stress acts on the pair of mother substrates S1 and S2, the pair of mother substrates S1 and S2 can be prevented from being warped in the convex shape.

Moreover, after the pair of mother substrates S1 and S2 are bonded, preferably, in the peripheral portion of the pair of mother substrates S1 and S2, at least a portion outside the sealing region 801 in which the second columnar spacers 401b are formed is cut off. Thus, the second columnar spacers 401b formed in the peripheral portion of the pair of mother substrates S1 and S2 can be removed from the respective panel forming regions 810.

### 4: Electronic Apparatus

Next, examples in which liquid crystal devices such as the above-mentioned electro-optical devices are applied to various electronic apparatuses will be described.

<4-1: Projector>

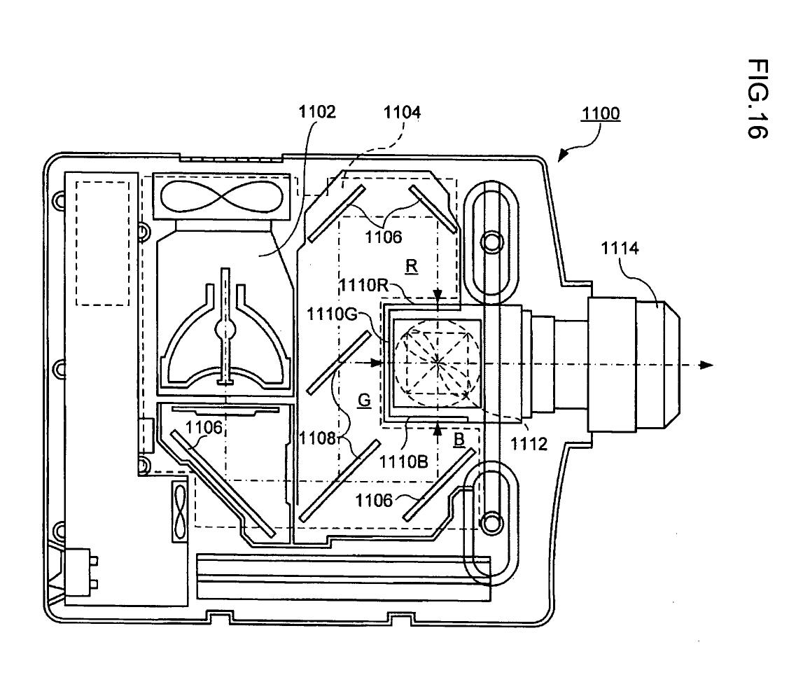

First, a projector in which the liquid crystal device is used as a light valve will be described. FIG. 16 is a plan view showing an example of a configuration of a projector. As shown in FIG. 16, within the projector 1100, a lamp unit 1102 which comprises white light sources such as halogen lamps is provided. Light emitted from the lamp unit 1102 is separated into light components of three primary color of RGB by means of four mirrors 1106 arranged within a light guide 1104 and two dichroic mirrors 1108. The separated light components are respectively incident to liquid crystal panels 1110R, 1110B and 1110G which serve as light valves corresponding to the respective primary colors.

The configurations of the liquid crystal panels 1110R, 1110B and 1110G are the same as that of the above-mentioned liquid crystal panel 100. The liquid crystal panels 1110R, 1110B and 1110G are driven by means of the respective primary color signals of R, G and B which are supplied from an image signal processing circuit. And then, light components modulated by the liquid crystal panels are incident to a dichroic prism 1112 in three directions. In the dichroic prism 1112, the light components of R and B are refracted by 90 degrees, and the light component of G goes straight ahead. Therefore, images of the respective colors are synthesized, such that a color image is projected on a screen via a projective lens 1114.

Here, referring to display images by means of the respective liquid crystal panels 1110R, 1110B and 1110G, the display image of the liquid crystal panel 1110G is needed to be inverted from side to side with respect to the display images by means of the liquid crystal panels 1110R and 1110B.

Moreover, since the light components corresponding to the respective primary colors of R, G and B are incident to the liquid crystal panels 1110R, 1110B and 1110G by means of the dichroic mirror 1108, there is no providing a color filter.

<4-2: Mobile Computer>

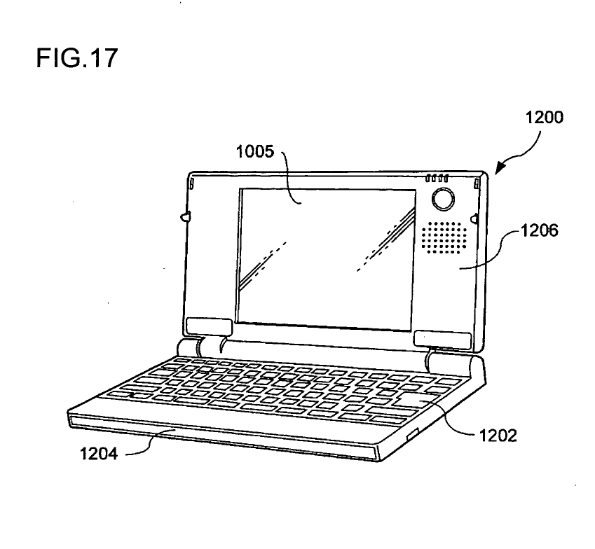

Next, an example in which the liquid crystal device is applied to a mobile personal computer will be described. FIG. 17 is a perspective view showing a configuration of the personal computer. In FIG. 17, the computer 1200 comprises a main body 1204 having a keyboard 1202, and a liquid crystal display unit 1206. The liquid crystal display unit 1206 is made by adding a backlight to the rear surface of the above-mentioned liquid crystal panel 1005.

<4-3: Cellular Phone>

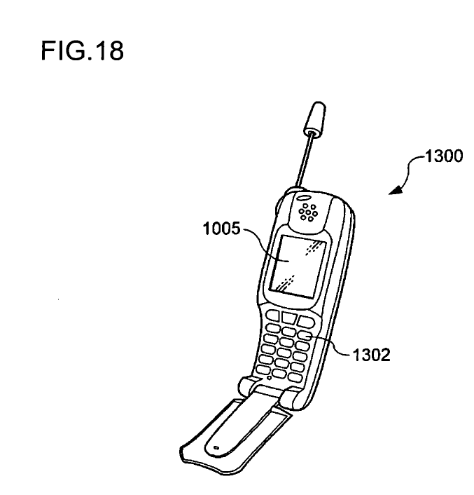

In addition, an example in which a liquid crystal device is applied to a cellular phone will be described. FIG. 18 is a perspective view showing a configuration of the cellular phone. In FIG. 18, the cellular phone 1300 has a plurality of operating buttons 1302 and a reflective liquid crystal panel 1005. As regards the reflective liquid crystal device 1005, if necessary, a front light is provided in a front surface thereof.

Moreover, in addition to the electronic apparatuses described with reference to FIGS. 16 to 18, a liquid crystal television, a view finder type or monitor-direct-view type video tape recorder, a car navigation device, a pager, an electronic organizer, an electronic calculator, a word processor, a workstation, a videophone, a POS terminal, a device having a touch panel or the like may be exemplified. And then, it is needless to say that the present invention can be applied to these electronic apparatuses.

The present invention is not limited to the above-mentioned embodiments, but various modifications can be made within a scope without departing from a spirit or an idea of the present invention to be read on the claims and the specification. An electro-optical device, a method of manufacturing the same, and an electronic apparatus having the electro-optical device are also included in a technical scope of the present invention.

1. An electro-optical device comprising:
a pair of substrates with an electro-optical material interposed therebetween;
a sealing material, formed between the pair of substrates and in a sealing region which is disposed around an image display region on one substrate, for bonding the pair of substrates to each other; and
first columnar spacers and second columnar spacers which are respectively provided to keep a gap between the pair of substrates in the image display region at a predetermined value,
wherein, between the pair of substrates, the first columnar spacers are arranged in the image display region and the second columnar spacers are arranged outside the sealing region in a peripheral region which is disposed around the image display region.

2. The electro-optical device according to claim 1,
wherein, in the peripheral region, the second columnar spacers are provided with the sealing material in the sealing region, or, in addition to or instead of the sealing material, the second columnar spacers are arranged within the sealing region.

3. The electro-optical device according to claim 1,
wherein the first columnar spacers have different heights from the second columnar spacers.

4. The electro-optical device according to claim 1,
wherein the first columnar spacers have different sectional areas from the second columnar spacers when being cut in a direction orthogonal to a height direction thereof.

5. The electro-optical device according to claim 1,
wherein, between the pair of substrates, the first columnar spacers are formed with a different formation density from the second columnar spacers.

6. The electro-optical device according to claim 1,
wherein the first and second columnar spacers are provided on one of the pair of substrates.

7. The electro-optical device according to claim 1,
wherein the first columnar spacers are provided on one of the pair of substrates, and
the second columnar spacers are provided on the other substrate.

8. The electro-optical device according to claim 1,
wherein, on at least one of the pair of substrates on which the first or second columnar spacers are provided, a dummy layer is provided outside the sealing region, and
the second columnar spacers are provided below or above the dummy layer.

9. The electro-optical device according to claim 1,
wherein, on at least one of the pair of substrates on which the first or second columnar spacers are provided, a laminated structure which extends from the image display region to the peripheral region is formed.

10. The electro-optical device according to claim 9,
wherein the laminated structure includes a light-shielding film which defines a non-opened region for every pixel in the image display region, and
the first columnar spacers are provided below the light-shielding film.

11. The electro-optical device according to claim 9,
wherein the laminated structure includes a colored layer which is formed for every pixel in the image display region.

12. The electro-optical device according to claim 9,
wherein the laminated structure includes a reflecting film which is formed for every pixel in the image display region and defines a transmission display region and a reflection display region in each pixel.

13. The electro-optical device according to claim 12,
wherein the laminated structure further includes a step forming film which is formed in the reflection display region.

14. The electro-optical device according to claim 13,
wherein the step forming film is further formed outside the sealing region, and
the second columnar spacers are provided below or above the step forming film.

15. An electronic apparatus comprising an electro-optical device as claimed in claim 1.

16. A method of manufacturing an electro-optical device which comprises a pair of substrates with an electro-optical material interposed between, the pair of substrates being formed by cutting a pair of mother substrates for every panel forming region, the method comprising:
a step of forming first columnar spacers inside a sealing region in each of a plurality of panel forming regions on at least one of the pair of mother substrates;
a step of forming second columnar spacers outside the plurality of panel forming regions in a peripheral portion of the pair of mother substrates on at least one of the pair of mother substrates; and
a step of forming a sealing material in the sealing region between the pair of mother substrates such that the first columnar spacers and the second columnar spacers are interposed therebetween, and bonding the pair of mother substrates.

17. The method of manufacturing an electro-optical device according to claim 16, further comprising:
a step of cutting and removing at least a portion of a region of the peripheral portion, in which the second columnar spacers are formed, from the electro-optical device.
